(19) United States
(12) Patent Application Publication
(10) Pub. No.: US 2025/0229355 A1
(43) Pub. Date: Jul. 17, 2025

(54) CURRENT CONTROL METHOD AND CONTROL DEVICE IN RESISTANCE SPOT WELDING

(71) Applicant: TOYOTA JIDOSHA KABUSHIKI KAISHA, Toyota-shi, Aichi-ken (JP)

(72) Inventors: Tomohiko SEKIGUCHI, Nagakute-shi (JP); Kyosuke IZUNO, Nisshin-shi (JP); Yosuke TAMADA, Toyota-shi (JP); Yasuaki OKITA, Chiba-shi (JP)

(73) Assignee: TOYOTA JIDOSHA KABUSHIKI KAISHA, Toyota-shi, Aichi-ken (JP)

(21) Appl. No.: 18/853,750

(22) PCT Filed: Apr. 14, 2023
(86) PCT No.: PCT/JP2023/015163

§ 371 Date: Oct. 3, 2024

(30) Foreign Application Priority Data
Apr. 26, 2022 (JP) 2022-071996

(51) Int. Cl. B23K 11/24; B23K 11/11

(52) U.S. Cl. CPC B23K 11/241; B23K 11/115

(57) ABSTRACT

Provided is a current control method for resistance spot welding in which a plurality of overlapped metal plates are welded together by being sandwiched between a pair of electrodes and energized while applying pressure. The current control method includes sequentially acquiring an electrical resistance between the pair of electrodes during welding; sequentially calculating an expansion amount caused by the welding using a strain calculated from the pressure applied by the electrodes and a stroke of the electrode; sequentially calculating a computational nugget diameter by using the electrical resistance and the expansion amount, the computational nugget diameter being a diameter of a nugget formed during the welding; and sequentially determining a current to be applied between the pair of electrodes during the welding using a difference between the computational nugget diameter and a master computational nugget diameter calculated in master welding in which no gap exists between the metal plates and a nugget with a target diameter is obtained by the welding.

### CROSS REFERENCE TO RELATED APPLICATIONS

This application is based upon and claims the benefit of priority from the prior Japanese Patent Application No. 2022-71996, filed on Apr. 26, 2022, the content of which is incorporated herein by reference in its entirety.

### TECHNICAL FIELD

The present disclosure relates to resistance spot welding.

### BACKGROUND ART

International Publication WO 2014/156290 discloses a resistance spot welding system. This resistance spot welding system computes a change over time in instantaneous heat generated amount, which is calculated from the electrical characteristics between electrodes during test welding when forming an appropriate nugget through energization under constant current control. Based on this change over time in the instantaneous heat generated amount, an energizing pattern is divided into multiple steps by external input after test welding. The change over time in the instantaneous heat generated amount and the accumulated heat generated amount for each step are stored as target values. At the time of main welding, the welding is started using as the reference, a curve that represents the change over time in the instantaneous heat generated amount, which has been stored as a target value. If the change over time in the instantaneous heat generated amount deviates from its target curve in any one of the steps, the welding current or voltage is adjusted during the welding such that the instantaneous heat generated amount compensates the deviation within the remaining energizing time of the step and the accumulated heat generated amount matches the target accumulated heat generated amount for the step.

### SUMMARY OF THE INVENTION

### Technical Problem

However, it is difficult for such a conventional resistance spot welding method to enlarge the nugget diameter to the target value in the event of disturbances, such as a gap existing between two plates to be welded.

### Solution to Problem

The present disclosure can be implemented by having the following aspects.

(1) According to a first aspect of the present disclosure, there is provided a current control method for resistance spot welding in which a plurality of overlapped metal plates are welded together by being sandwiched between a pair of electrodes and energized while applying pressure thereto. The current control method includes (A) sequentially acquiring an electrical resistance between the pair of electrodes during welding; (B) sequentially calculating an expansion amount caused by the welding using a strain calculated from the pressure applied by the electrodes and a stroke of the electrode; (C) sequentially calculating a computational nugget diameter by using the electrical resistance and the expansion amount, the computational nugget diameter being a diameter of a nugget formed during the welding; and (D) sequentially determining a current to be applied between the pair of electrodes during the welding by using a difference between the computational nugget diameter and a master computational nugget diameter calculated in master welding, in which no gap exists between the metal plates and a nugget with a target diameter is obtained by the welding. According to the current control method of this aspect, the nugget diameter can be enlarged to the target value in the event of disturbances, such as a gap existing between the plates to be welded.

(2) In the above-mentioned aspect, the current control method may further include, prior to the steps (A) to (D), determining a current to be applied between the pair of electrodes based on a predetermined current waveform from the start of the energization of the pair of electrodes up to a predetermined timing.

(3) In the above-mentioned aspect, the predetermined timing may be a timing when a nugget begins to be formed.

(4) In the above-mentioned aspect, in the step (D), the current may be sequentially determined using a product of the difference and a value obtained by multiplying the computational nugget diameter by a predetermined exponent.

(5) According to a second aspect of the present disclosure, there is provided a control device for resistance spot welding in which a plurality of overlapped metal plates are welded together by being sandwiched between a pair of electrodes and energized while applying pressure thereto. The control device includes: a resistance acquisition unit that sequentially acquires an electrical resistance between the pair of electrodes during welding; an expansion amount calculation unit that sequentially calculates an expansion amount caused by welding using a strain calculated from a pressure applied by the electrodes and a stroke of the electrode; a nugget diameter calculation unit that sequentially calculates a computational nugget diameter by using the electrical resistance and the expansion amount, the computational nugget diameter being a diameter of a nugget formed during the welding; and a current determination unit that sequentially determines a current to be applied between the pair of electrodes during the welding by using a difference between the computational nugget diameter and a master computational nugget diameter calculated in master welding, in which no gap exists between the metal plates and a nugget with a target diameter is obtained by the welding.

The present disclosure can also be implemented in various aspects other than the current control method and control device described above. For example, it can be implemented in the form of a resistance spot welding method, a resistance spot welding system, a computer program, a non-transitory tangible recording medium that records a computer program, and the like.

### BRIEF DESCRIPTION OF THE DRAWINGS

FIG. 1 is a diagram showing a configuration of a resistance spot welding system of a first embodiment;

FIG. 2 is a control flowchart of a master welding process sequentially performed by a control unit;

FIG. 3 is a graph showing an applied pressure;

FIG. 4 is a graph showing a stroke;

FIG. 5 is a graph showing an expansion amount;

FIG. 6 is a graph showing a master current;

FIG. 7 is a graph comparing a computational nugget diameter calculated using an equation (3) with an actual measured nugget diameter;

FIG. 8 is a graph comparing the computational nugget diameter calculated only from information at the end of energization with the actual measured nugget diameter;

FIG. 9 is a control flowchart of a main welding process sequentially performed by the control unit;

FIG. 10 is an explanatory diagram showing the master current applied during master welding and the current applied during main welding, under control of the control unit;

FIG. 11 is an explanatory diagram showing the master computational nugget diameter in the master welding and the computational nugget diameter in the main welding;

FIG. 12 is a comparison diagram of the actual measured nugget diameters;

FIG. 13 is an explanatory diagram showing a current applied during the main welding in a second embodiment by comparing it with the master current applied during the master welding and the current applied during the main welding in the first embodiment; and

FIG. 14 is a comparison diagram of the actual measured nugget diameters.

### DETAILED DESCRIPTION

### A. First Embodiment

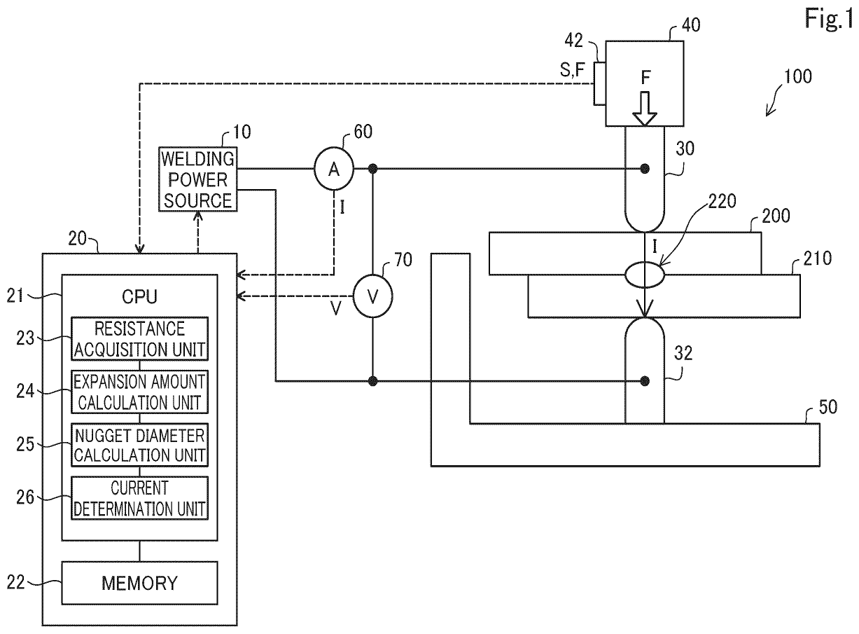

FIG. 1 is a diagram showing a configuration of a resistance spot welding system 100 of a first embodiment. The resistance spot welding system 100 includes a spot welding power source 10, a control unit 20, a pair of electrodes 30 and 32, a pressurizing cylinder 40, a lower arm 50, an ammeter 60, and a voltmeter 70.

Metal plates 200 and 210 to be welded are sandwiched between the pair of electrodes 30 and 32. The electrode 30 is provided on the pressurizing cylinder 40. The electrode 32 is provided on the lower arm 50. The pressurizing cylinder 40 presses the electrode 30 toward the metal plate 200 with an applied pressure F. The pressurizing cylinder 40 is provided with a pressure sensor 42. The pressure sensor 42 measures the applied pressure F and a stroke S of the electrode 30 when the pressure is applied. The electrodes 30 and 32 are connected to the spot welding power source 10. The ammeter 60 measures a current I flowing between the electrodes 30 and 32. The voltmeter 70 measures a voltage V applied between the electrodes 30 and 32.

When the current I flows between the two electrodes 30 and 32, Joule heat is generated due to a contact resistance R between the two metal plates 200 and 210. When the applied pressure F is large, the contact resistance R is small, whereas when the applied pressure F is small, the contact resistance R is large. The generated Joule heat melts a part of the metal plates 200 and 210 at an interface between the two metal plates 200 and 210. Thereafter, when the energization is stopped, the molten metal cools and solidifies, generating a nugget 220 at a boundary of the two metal plates 200 and 210. The nugget 220 has a flat shape along the interface between the two metal plates 200 and 210 and bonds the two metal plates 200 and 210 by welding. The strength of a weld depends on the nugget diameter. The larger the nugget diameter of the nugget 220, the stronger the strength of the weld between the two metal plates 200 and 210.

The control unit 20 is a controller that controls the current I applied between the electrodes 30 and 32 during welding. The control unit 20 is composed of a computer including a processor 21 and a memory 22. The processor 21 functions as a resistance acquisition unit 23, an expansion amount calculation unit 24, a nugget diameter calculation unit 25, or a current determination unit 26 by executing a program stored in the memory 22. The program may be recorded on a non-transitory tangible computer-readable recording medium.

The resistance acquisition unit 23 sequentially acquires the electrical resistance between the pair of electrodes 30 and 32 during welding. The expansion amount calculation unit 24 sequentially calculates the expansion amount caused by the welding, using the strain calculated from the applied pressure by the electrodes 30 and 32 and the stroke S of the electrode 30. The nugget diameter calculation unit 25 sequentially calculates the computational nugget diameter, which is the diameter of the nugget during the welding, using the electrical resistance and the expansion amount. The current determination unit 26 sequentially determines during the welding the current to be applied between the pair of electrodes, using the difference between the computational nugget diameter and the master computational nugget diameter. The master computational nugget diameter is the nugget diameter calculated in the master welding in which no gap exists between the metal plates and a nugget with the target diameter is obtained by the welding. These functional units may be implemented by circuitry.

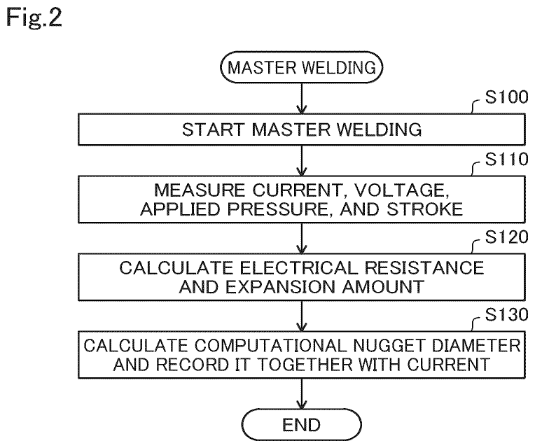

FIG. 2 is a control flowchart of a master welding process sequentially performed by the control unit 20. The master welding refers to ideal welding where no gap exists between the two metal plates 200 and 210 and the target nugget diameter can be achieved by the welding. In the master welding process, the control unit 20 acquires various parameters for controlling the welding used in the main welding, such as master current I_{M}, applied voltage V, electrical resistance, applied pressure F, and stroke S, and records them as a master pattern.

In step S100, the control unit 20 starts the master welding by causing the current I to be applied between the electrodes 30 and 32 while applying pressure. In step S110, the control unit 20 sequentially measures the voltage V between the two electrodes 30 and 32, the current I applied between the two electrodes 30 and 32, the applied pressure F of the pressurizing cylinder 40, and the stroke S of the electrode 30 in the master welding.

In step S120, the control unit 20 calculates the electrical resistance between the two metal plates 200 and 210 and an expansion amount E of the nugget in a thickness direction. The resistance acquisition unit 23 of the control unit 20 sequentially calculates and acquires the electrical resistance from the measured current I and voltage V according to Ohm's law. The electrical resistance is approximately equal to the contact resistance R. The expansion amount calculation unit 24 of the control unit 20 sequentially calculates and acquires the expansion amount E by converting an amount of change ΔF in the applied pressure F into a stain amount and adding an amount of change ΔS in the stroke S thereto. Equation (1) for calculating the expansion amount E is as follows.

$$E = Δ S + a \cdot Δ F \qquad ( 1 )$$

In the equation (1), a coefficient a is a strain amount conversion coefficient. A second term in the equation (1) is the strain amount. As an example, the strain amount conversion coefficient a is 0.00048. In this case, the equation (1) becomes an equation (2) below.

$$E = Δ S + 0.0 \; 0048 \cdot Δ F \qquad ( 2 )$$

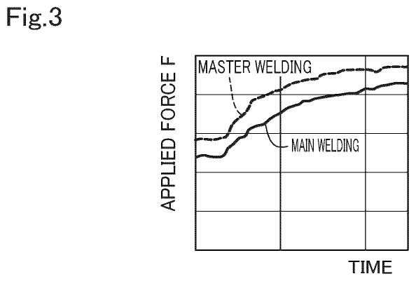

FIG. 3 is a graph showing the applied pressure F. In addition to the applied pressure F in the master welding, FIG. 3 also shows the applied pressure F in the main welding described later. In the master welding, the metal plates are welded to each other with no gap at a location to be welded. In the main welding, two metal plates with a gap of 2 mm at the location to be welded are welded together. The applied pressure F is greater in the master welding where no gap exists between the metal plates than in the main welding where a gap of 2 mm exists between the metal plates. The applied pressure F in the main welding depends on the condition of the two metal plates 200 and 210 to be welded, for example, on the size of the gap between the two metal plates 200 and 210 at the welding location and a surface condition of the interface between the metal plates 200 and 210.

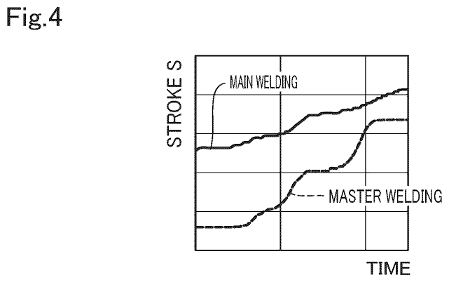

FIG. 4 is a graph showing the stroke S. In addition to the stroke S in the master welding, FIG. 4 also shows the stroke S in the main welding, as in FIG. 3. The stroke S is greater in the master welding where a gap of 2 mm exists between the metal plates than in the master welding where no gap exists between the metal plates. As in the applied pressure F, the stroke S in the main welding depends on the condition of the two metal plates 200 and 210 to be welded, for example, on the size of the gap between the two metal plates 200 and 210 at the welding location and the surface condition of the interface between the metal plates 200 and 210.

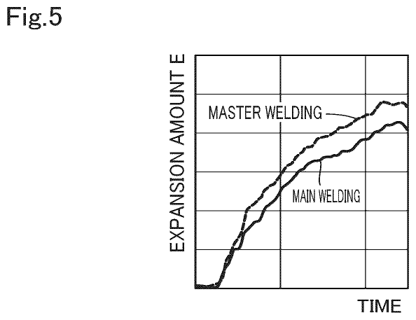

FIG. 5 is a graph showing the expansion amount E. In addition to the expansion amount E in the master welding, FIG. 5 also shows the expansion amount E in the main welding, as in FIGS. 3 and 4. The expansion amount E is greater in the master welding where no gap exists between the metal plates than in the main welding where a gap of 2 mm exists between the metal plates. The expansion amount E in the thickness direction is correlated with the nugget diameter along the interface between the metal plates.

In step S130 of FIG. 2, the nugget diameter calculation unit 25 of the control unit 20 sequentially calculates a computational nugget diameter ANI. For example, the nugget diameter calculation unit 25 sequentially calculates the computational nugget diameter ANI at any timing in a current control interval according to the following equation (3).

$$ANI = C 1 \cdot Δ R + C 2 \cdot {E}_{max} + C 3 \cdot \int E + C 4 \qquad ( 3 )$$

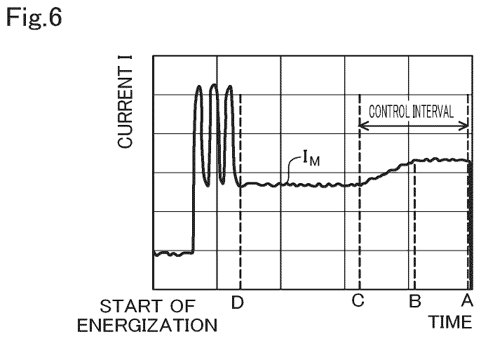

In the equation (3), ΔR is an amount of change in the electrical resistance. Eₘₐₓ is the maximum value of the expansion amount E. ∫E is an integral value of the expansion amount E. C1, C2, C3, and C4 are constants determined by experiment or multiple regression analysis. The amount of change ΔR in the electrical resistance, the maximum value Eₘₐₓ of the expansion amount E, and the integral value ∫E of the expansion amount E will be described in detail using FIG. 6. The computational nugget diameter ANI also refers to a computational nugget diameter in the master welding, and thus can also be called a “master computational nugget diameter ANI_{M}”. The control unit 20 records the current I applied during the master welding as a master current I_{M}, and the master computational nugget diameter ANI_{M} and the master current I_{M} as a master pattern.

FIG. 6 is a graph showing the master current I_{M}. The control unit 20 causes the large master current I_{M} to be applied three times from the start of energization to timing D. The reason for applying the large master current I_{M} three times is to form an alloy layer in a short time. The control unit 20 causes the master current I_{M} with almost constant magnitude to be applied from the timing D to timing C. By applying the master current I_{M} with almost constant magnitude, the contact condition of the metal plates can be made smooth. Thereafter, the control unit 20 gradually increases the master current I_{M} from the timing C to timing B. The control unit 20 causes the master current I_{M} with almost constant magnitude to be applied from the timing B to timing A. The control unit 20 stops the energization at the timing A.

An interval from the start of energization to the timing D is a preparation interval for forming a nugget. In the interval from the start of energization to the timing D, the control unit 20 determines the current to be applied to the pair of electrodes 30 and 32 according to the predetermined current waveform. The interval from the timing C to the timing A is a control interval for growing the nugget to the target size. The timing C, which is the timing of the start of the control interval, is also the timing when the nugget begins to be formed. In other words, the timing C is the timing when the metal plates begin to melt each other. The above timings D, C, B, and A are predetermined according to a combination of metal plates. For example, depending on the combination of the metal plates, a nugget may begin to be formed at the timing D. In such a case, the control unit 20 matches the timing C with the timing D. When the timing C is matched to the timing D, the master current I_{M} gradually increases from the timing D (=timing C) toward the timing B, and thus an interval where the master current I_{M} with almost constant magnitude is applied is eliminated between the timings D and B.

The amount of change ΔR in the electrical resistance described above is the integral value of the change in resistance from the electrical resistance between the two electrodes 30 and 32 at the timing D to the electrical resistance between the two electrodes 30 and 32 when the energization is stopped. The maximum value Eₘₐₓ of the expansion amount E is the maximum value of the expansion amount E between the start of the energization and the stop of the energization. As can be seen from FIG. 5, the expansion amount E increases monotonically from the start of the energization, so that the maximum value Eₘₐₓ of the expansion amount E becomes the expansion amount E at the time of stopping the energization. The integral value ∫E of the expansion amount E is the integral of the expansion amount E from the start of the energization to the stop of the energization.

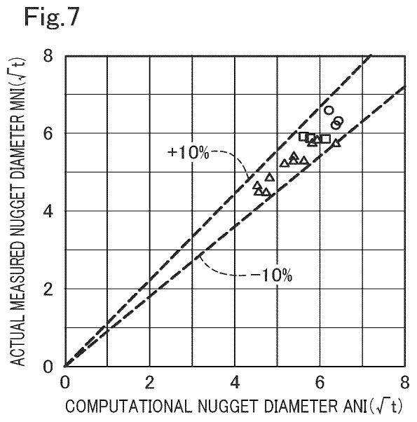

FIG. 7 is a graph comparing the computational nugget diameter ANI calculated using the equation (3) with the actual measured nugget diameter MNI. A circular mark indicates a case where two metal plates 200 and 210 with no gap at the welding location are energized up to the timing A. A square mark indicates a case where two metal plates 200 and 210 with a gap of 2 mm at the welding location are energized up to the timing A. Triangle marks collectively indicate the following four cases: a case where two metal plates 200 and 210 with no gap are energized up to the timing B; a case where two metal plates 200 and 210 with no gap are energized up to the timing C; a case where two metal plates 200 and 210 with a gap of 2 mm are energized up to the timing B; and a case where two metal plates 200 and 210 with a gap of 2 mm are energized up to the timing C. In the equation (3) for calculating the graph in FIG. 7, each of the constants in the equation (3) is determined using information (electrical resistance, expansion amount, etc.) about samples energized up to the timings B and C as well as the timing A.

The computational nugget diameter ANI shown in FIG. 7 falls within ±10% of the actual measured nugget diameter MNI. Therefore, by determining the equation (3) using the information acquired at various timings, the equation (3) becomes a reasonable equation for estimating the nugget diameter ANI, regardless of the condition of the two metal plates 200 and 210 at the welding location and the timing of stopping the energization. The “t” in FIGS. 7, 8, 12, and 14 represents the thickness of a thinner one of the two metal plates to be welded.

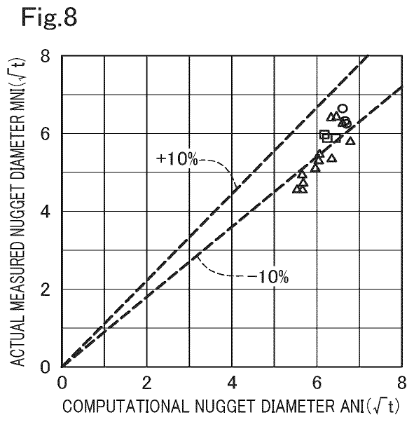

FIG. 8 is a graph that compares the actual measured nugget diameter MNI with the computational nugget diameter ANI calculated by the equation (3) having constants determined only from the information at the completion of energization, i.e., timing A. The size of the gap at each of the welding locations of the points indicated by the circles, squares, and triangles, and the stop timing of the energization thereof are the same as those in FIG. 7. When the equation (3) is determined only from the information at the timing A, the computational nugget diameter ANI is almost equal to the actual measured nugget diameter MNI in both cases of welding two metal plates 200 and 210 with no gap and of welding two metal plates 200 and 210 with a gap of 2 mm. However, when the energization is performed up to only the timing B or C, the actual measured nugget diameter MNI is smaller than the computational nugget diameter ANI in both cases of welding two metal plates 200 and 210 with no gap and of welding two metal plates 200 and 210 with a gap of 2 mm. In other words, when the equation (3) is determined only from the information at the timing A, the accuracy of estimating the computational nugget diameter ANI midway through the control interval is found to become lower than when the equation (3) is determined using the information at the timing B and C as well.

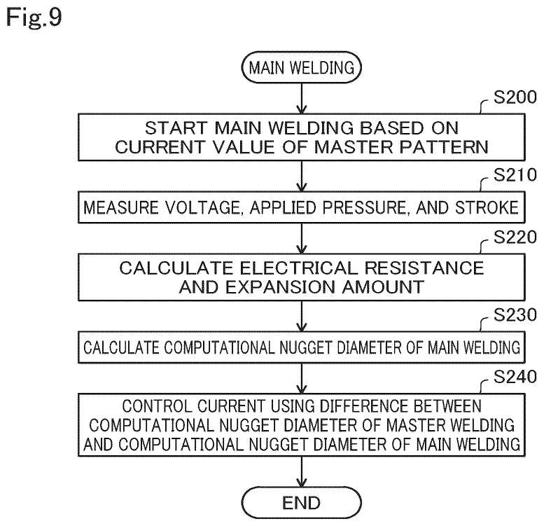

FIG. 9 is a control flowchart of a main welding process sequentially performed by the control unit 20. In step S200, the control unit 20 starts welding by energizing while applying pressure, using the master current I_{M} recorded during the master welding as the reference.

In step S210, the control unit 20 sequentially measures the voltage V between the two electrodes 30 and 32, the current I, the applied pressure F of the pressurizing cylinder 40, and the stroke S of the electrode 30, as in step S110 in the master welding (see FIG. 2). The control unit 20 causes the current to be applied according to the predetermined current waveform up to the timing C where the nugget begins to be formed, in the same manner as the master current I_{M}. Thus, until the timing C, the current to be applied between the pair of electrodes 30 and 32 is determined based on the predetermined current waveform. The control unit 20 causes the current I₁ described later to be applied after the timing C. In step S220, the control unit 20 sequentially acquires the electrical resistance between the two metal plates 200 and 210 and sequentially calculates the expansion amount E, as in step S120 of the master welding (see FIG. 2). In step S230, the control unit 20 sequentially calculates the computational nugget diameter ANI by using the equation (3), as in step S130 of the master welding (see FIG. 2).

In step S240, the current determination unit 26 of the control unit 20 sequentially determines the current I₁ to be applied during the main welding by using a difference ΔANI between the computational nugget diameter ANI in the master welding and the computational nugget diameter ANI in the main welding during a control interval from the timing C to the timing A in FIG. 6, and controls the current. Here, the computational nugget diameter in the master welding is called a master computational nugget diameter ANI_{M}, while the computational nugget diameter in the main welding is called a computational nugget diameter ANI₁. The control equation (4) used for the current control executed by the control unit 20 is as follows. The control equation (4) is an equation determined by experiment.

$${I}_{1} ( {t}_{2} ) = {I}_{M} ( {t}_{2} ) + C 3 \cdot Δ ANI ( {t}_{1} ) + C 5 \qquad ( 4 )$$

In the control equation (4), ΔANI(t₁) is a difference between the master computational nugget diameter ANI_{M} and the computational nugget diameter ANI₁ in the main welding at a timing t₁. I₁(t₂) is a current at a timing t₂ when Δt has passed since the timing t₁. I_{M}(t₂) is a master current at the timing t₂. C3 and C5 are constants and are determined by experiment or multiple regression analysis. Δt is a control interval during which the control unit 20 sequentially calculates the current I₁ (t₂), for example, 2 ms. That is, the control unit 20 calculates the current I₁(t) every 2 ms. The control interval Δt may be an interval other than 2 ms, such as 0.5 ms, 1 ms, or 3 ms.

As an example, in the control equation (4), the constant C3 is 540, and the constant C5 is 0. In this case, the control equation (4) becomes the following control equation (5).

$${I}_{1} ( {t}_{2} ) = {I}_{M} ( {t}_{2} ) + 540 \cdot Δ ANI ( {t}_{1} ) \qquad ( 5 )$$

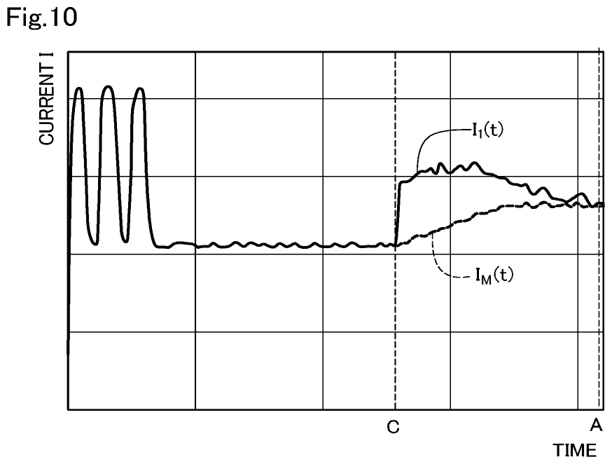

FIG. 10 is an explanatory diagram showing the master current I_{M}(t) applied during the master welding under control of the control unit 20 and the current I₁(t) applied during the main welding. The control unit 20 controls the current in the main welding using the master current I_{M} as the reference till the timing C in FIG. 6, and also controls the current by sequentially determining the current I₁(t) in the main welding through use of the control equation (5) from the timing C to the timing A.

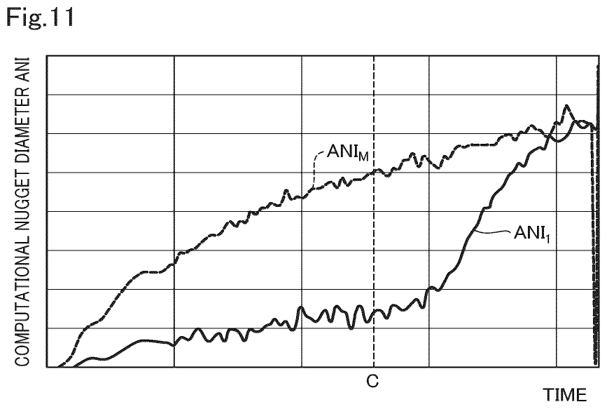

FIG. 11 is an explanatory diagram showing the master computational nugget diameter ANI_{M} and the computational nugget diameter ANI₁ in the main welding. At the timing C, when the control unit 20 starts the control using the current I₁(t), the computational nugget diameter ANI₁ in the main welding is smaller than the master computational nugget diameter ANI_{M}. As a result, ΔANI(t₁), which is the second term of the control equation (5), is large. The control unit 20 rapidly increases the current I₁(t) in the main welding and the current I₁(t) become greater than the master current I_{M}(t) in the master welding. As the welding proceeds in this condition and the computational nugget diameter ANI₁ in the main welding becomes larger, ΔANI(t₁), the second term of the control equation (5), which is the difference from the master computational nugget diameter ANI_{M}, becomes smaller. The control unit 20 brings the current I₁(t) in the main welding closer to the master current I_{M}(t₂).

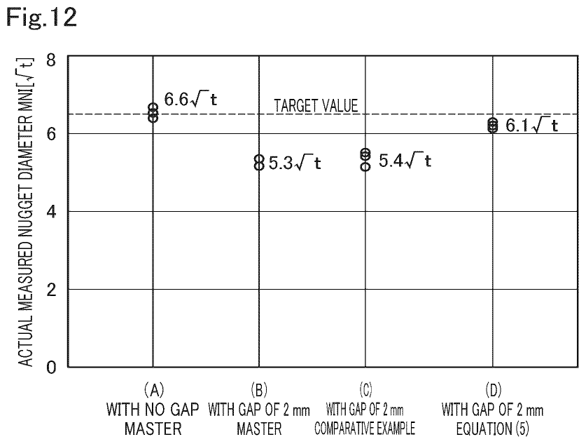

FIG. 12 is a comparison diagram of the actual measured nugget diameters. An example (A) shows a case where two metal plates 200 and 210 with no gap are welded together by applying the master current I_{M}. An example (B) shows a case where two metal plates 200 and 210 with a gap of 2 mm are welded together by applying the master current I_{M}. An example (C) shows a case where two metal plates 200 and 210 with a gap of 2 mm are welded together by applying a current under conventional current control. The conventional current control is one that determines a current based on a difference between electrical resistances in the master welding and in the main welding. An example (D) shows a case where two metal plates 200 and 210 with a gap of 2 mm are welded together by applying a current that has been sequentially calculated by using the control equation (5) in the first embodiment.

In the example (B) where the two metal plates 200 and 210 with a gap of 2 mm are welded together by applying the master current I_{M}, the actual measured nugget diameter MNI is 5.3√t, which is short of the target value of 6.6√t for the actual measured nugget diameter MNI. In the example (C) where two metal plates 200 and 210 with a gap of 2 mm are welded together by applying the current under the conventional current control, the actual measured nugget diameter MNI is 5.4√t, which is similarly short of the target value of 6.6√t for the actual measured nugget diameter MNI. In contrast, in the first embodiment (D), where the two metal plates 200 and 210 with a gap of 2 mm are welded together by applying the current sequentially calculated using the control equation (5), the actual measured nugget diameter MNI was 6.1√t, and it is closer to the actual measured nugget diameter of 6.6√t in the master welding (A), i.e., the target value, compared to the case (B) where the two metal plates 200 and 210 with a gap of 2 mm are welded together by applying the master current I_{M}, or the case (C) where the two metal plates 200 and 210 with a gap of 2 mm are welded together by applying the current under the conventional current control.

As described above, according to the first embodiment, the control unit 20 performs the control by sequentially calculating the computational nugget diameter ANI₁ through use of the electrical resistance and the expansion amount E during the energization and also by sequentially calculating the current I₁(t) in the main welding through use of the difference between the computational nugget diameter ANI₁ and the computational nugget diameter ANI_{M} in the master welding. As a result, in the first embodiment, even in the event of disturbances, such as a gap existing between the two plates to be welded, the actual measured nugget diameter MNI₁ can be made closer to the actual measured nugget diameter MNI_{M} in the master welding, which is the target value.

### B. Second Embodiment

In the first embodiment, during the welding, the current determination unit 26 of the control unit 20 sequentially determines the current to be applied at the time of the energization by using the difference between the computational nugget diameter and the master computational nugget diameter. In contrast, in the second embodiment, the current determination unit 26 sequentially determines the energization current by using the product of the difference between the computational nugget diameter and the master computational nugget diameter and a value obtained by multiplying the computational nugget diameter by a predetermined exponent. In the second embodiment, the configuration of the resistance spot welding system 100 and the equation for calculating the computational nugget diameter are the same as those in the first embodiment.

The control equation (6) used for the current control sequentially executed by the control unit 20 in the second embodiment is as follows. The control equation (6) is an equation determined by experiment.

$${I}_{2} ( {t}_{2} ) = {I}_{M} ( {t}_{2} ) + C 3 \cdot Δ ANI ( {t}_{1} ) {ANI}^{C 4} ( {t}_{1} ) + C 5 \qquad ( 6 )$$

In the control equation (6), I_{M}(t₂) is the master current. ANI(t₁) is the calculated nugget diameter, and ΔANI(t₁) is a difference between the master computational nugget diameter ANI_{M} and the computational nugget diameter ANI₁ in the main welding at the timing t₁. C3, C4 and C5 are constants and are determined by experiment or multiple regression analysis.

As an example, the constant C3 in the control equation (6) is 90, the constant C2 is 2, and the constant C5 is 0. In this case, the control equation (6) becomes the following control equation (7).

$${I}_{2} ( {t}_{2} ) = {I}_{M} ( {t}_{2} ) + 90 \cdot Δ ANI ( {t}_{1} ) \cdot {ANI}^{2} ( {t}_{1} ) \qquad ( 7 )$$

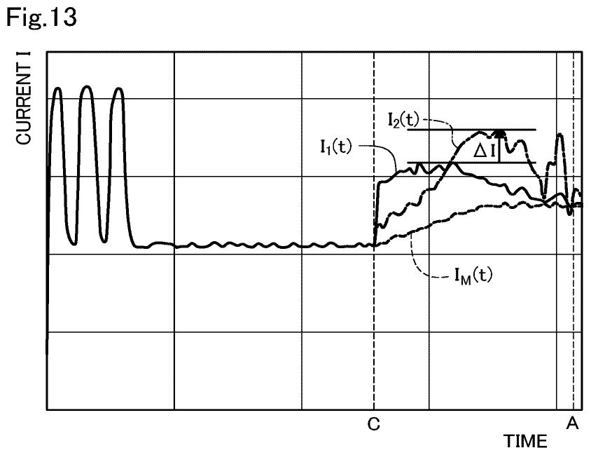

FIG. 13 is an explanatory diagram showing a current I₂(t) applied during the main welding under control of the control unit 20 in the second embodiment by comparing it with the master current I_{M}(t) and the current I₁(t) applied during the main welding in the first embodiment. In the second embodiment, as in the first embodiment, the control unit 20 causes the current to be applied according to the predetermined current waveform until the timing C. The control unit 20 causes the current sequentially calculated according to the control equation (7) to be applied from the timing C to the timing A. The current I₂(t) applied during the main welding at an initial stage of the control for a while after the timing C in the second embodiment is smaller than the current I₁(t) applied during the main welding in the first embodiment. Meanwhile, at a late stage of the control, the current I₂(t) applied during the main welding in the second embodiment is larger than the current I₁(t) applied during the main welding in the first embodiment.

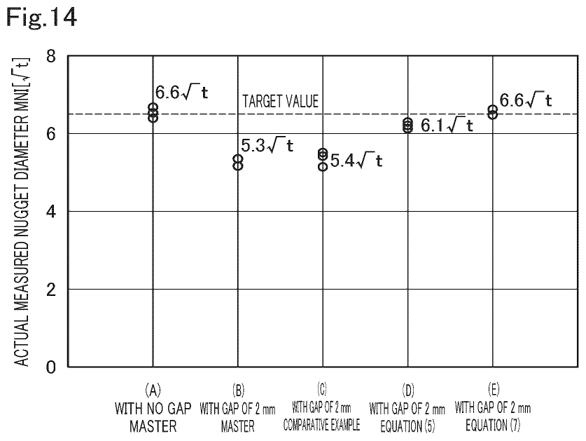

FIG. 14 is a comparison diagram of the actual measured nugget diameters. FIG. 14 shows, in addition to the cases of FIG. 12, a case where the two metal plates 200 and 210 with a gap of 2 mm are welded together by applying the current I₂(t) that has been sequentially calculated by using the control equation (7) (the second embodiment (E)). The actual measured nugget diameter MNI₂ in the second embodiment (E) is 6.6√t, which is the same value as the actual measured nugget diameter MNI₁ of 6.6√t in the master welding (A), and is even closer to the target value, i.e., the actual measured nugget diameter of 6.6√t in the master welding, than the actual measured nugget diameter MNI₁ in the first embodiment (D).

According to the second embodiment, the actual measured nugget diameter MNI₂ can be made even closer to the target value than in the first embodiment.

According to the second embodiment, information on the nugget diameter at each timing (computational nugget diameter ANI(t)) is added to the control equation (7), so that a rapid increase in current I₂(t) can be suppressed at the initial stage of the control where the contact diameter is small, and the current I₂ can be increased as the nugget diameter and contact diameter are enlarged. Thus, a spatter limit current value can be increased, which results in an increased control range of the current and making the actual measured nugget diameter MNI₂ closer to the actual measured nugget diameter MNI_{M} in the master welding, which is the target value.

### C. Other Embodiments

(C1) In each of the above embodiments, the timing C, which is the timing of the start of the current control interval, is a timing when the nugget begins to be formed. In contrast, the timing C may be a timing when a nugget grows to a predetermined size at an initial stage of welding. Alternatively, the timing C may also be a timing immediately before the nugget begins to be formed.

(C2) In each of the above embodiments, an example of welding the two metal plates 200 and 210 overlapped each other has been described, but three or more of metal plates may also be welded. A member to be welded is not limited to a metal plate, but may also be a metal block.

The present disclosure is not limited to the above-described embodiments and can be implemented with various configurations without departing from its spirit. For example, the technical features in the embodiments corresponding to the technical features in each of the aspects described in “SUMMARY” may be replaced or combined as appropriate to solve some or all of the problems described above or to achieve some or all of the effects described above. Unless the technical feature is described herein as essential, it can be deleted as appropriate.

1. A current control method for resistance spot welding in which a plurality of overlapped metal plates are welded together by being sandwiched between a pair of electrodes and energized while applying pressure thereto, the method comprising:
(A) sequentially acquiring an electrical resistance between the pair of electrodes during welding;
(B) sequentially calculating an expansion amount caused by the welding using a strain calculated from the pressure applied by the electrodes and a stroke of the electrode;
(C) sequentially calculating a computational nugget diameter by using the electrical resistance and the expansion amount, the computational nugget diameter being a diameter of a nugget formed during the welding; and
(D) sequentially determining a current to be applied between the pair of electrodes during the welding by using a difference between the computational nugget diameter and a master computational nugget diameter calculated in master welding in which no gap exists between the metal plates and a nugget with a target diameter is obtained by the welding.

2. The current control method according to claim 1, further comprising:
prior to (A) to (D), determining a current to be applied between the pair of electrodes based on a predetermined current waveform from a start of the energization of the pair of electrodes up to a predetermined timing.

3. The current control method according to claim 2, wherein the predetermined timing is a timing when a nugget begins to be formed.

4. The current control method according to claim 1, wherein in (D), the current is sequentially determined using a product of the difference and a value obtained by multiplying the computational nugget diameter by a predetermined exponent.

5. A control device for resistance spot welding in which a plurality of overlapped metal plates are welded together by being sandwiched between a pair of electrodes and energized while applying pressure thereto, the control device comprising:
a resistance acquisition unit that sequentially acquires an electrical resistance between the pair of electrodes during welding;
an expansion amount calculation unit that sequentially calculates an expansion amount caused by the welding using a strain calculated from the pressure applied by the electrodes and a stroke of the electrode;
a nugget diameter calculation unit that sequentially calculates a computational nugget diameter by using the electrical resistance and the expansion amount, the computational nugget diameter being a diameter of a nugget formed during the welding; and
a current determination unit that sequentially determines a current to be applied between the pair of electrodes during the welding by using a difference between the computational nugget diameter and a master computational nugget diameter calculated in master welding in which no gap exists between the metal plates and a nugget with a target diameter is obtained by the welding.
